(19) United States
(12) Patent Application Publication
(10) Pub. No.: US 2013/0275091 A1
(43) Pub. Date: Oct. 17, 2013

(54) NON-PROGRAMMER METHOD FOR CREATING SIMULATION-ENABLED 3D ROBOTIC MODELS FOR IMMEDIATE ROBOTIC SIMULATION, WITHOUT PROGRAMMING INTERVENTION

(71) Applicants: Jack Elmin Peterson, Winnipeg (CA); Shane Nathaniel Richard Yanke, Winnipeg (CA); Jeffrey Craig Allen, Winnipeg (CA)

(72) Inventors: Jack Elmin Peterson, Winnipeg (CA); Shane Nathaniel Richard Yanke, Winnipeg (CA); Jeffrey Craig Allen, Winnipeg (CA)

(73) Assignee: COGMATION ROBOTICS INC., Winnipeg, MB (CA)

(21) Appl. No.: 13/811,290

(22) PCT Filed: Jul. 22, 2011
(86) PCT No.: PCT/CA2011/050449

§ 371 Date: Jul. 5, 2013

Related U.S. Application Data
(60) Provisional application No. 61/366,802, filed on Jul. 22, 2010.

(51) Int. Cl. G06F 17/50; G06T 19/00

(52) U.S. Cl. CPC G06F 17/5009; G06T 19/00
USPC 703/1

(57) ABSTRACT

A system to design a virtual 3D model of the working robot so it can be tested in a virtual world is described. The system and the method for using same can be used to test, refine, redesign and improve multiple virtual prototypes of a robot. Once virtually tested, the optimized design specifications are printed out and used to build the optimized robot design.

### PRIOR APPLICATION INFORMATION

The instant application claims the benefit of US Provisional Patent Application 61/366,802, filed Jul. 22, 2010.

### BACKGROUND OF THE INVENTION

Robots have existed for several decades in industry, manufacturing, space flight, toys, entertainment, movies and in academic research. A robot consists of the following parts:
1) Machine parts and electronics sensors, motors, arms, legs, wheels, cameras, etc that are designed and built into a machine that can obtain feedback about its environment and can react to this feedback;
2) A control behaviour program: A series of software instructions that come from either a remote control human operated device or that come from a computer program that defines the desired behaviour of the robot as it interacts with the sensors providing feedback data; and
3) A computer processor that obtains data from the sensors and provides instructions to the various moving or reacting parts.

Robots behave in a manner that may be controlled by a user via a wireless or wireline connection with a remote control “controller” in the hands of the user. Increasingly robots have been loaded with pre-written behaviours or control programs. If these behaviours do not require significant user direction, these behaviours are called “autonomous behaviours.” Developing both autonomous behaviours and remote controlled behaviours requires that the programs being developed are tested to correct and refine their operation. Each test iteration, which may identify an error or ‘bug“, must then be retested again. To finalize an autonomous behaviour can take dozens or even hundreds of iterations.

The design of a new robot's physical structure, and components can also benefit from simulation. Starting with the initial virtual prototype design, each next design iteration can be tested to illustrate what parts need to be improved. Once a new part is redesigned, the next iteration of the robot can be tested.

Each one of these iterations can take several minutes or more, even if the robot is on-site. In many cases, the robot is off site, and thus one test cycle could take days.

The main justification for using a robot simulator is to shorten the prototype and development cycle, by providing the developers with virtual robots which act like the real robots, and thus provide a reasonably accurate test setting.

To provide the capability to simulate a robot, a 3D visual model is required along with a program that will interpret the instructions of the “autonomous behaviour” and accurately cause the 3D virtual robot model to “act out” the behaviour defined in the control program. Within the simulator we need a physics engine to ensure that gravity, and all the other physics properties are adhered to as the 3D model “acts out” the instructions. To provide a realistic 3D graphical display we need a 3D rendering engine.

Currently most, if not all, robot simulators, require that the 3D model and the programming related to this model be an integral part of the simulation program in order for the robotic model to be simulated. In effect, the 3D model and the simulation program are combined into one simulator program for each specific robot.

Lego provides a simplified, limited structure for users to create their 3D visual model using a mouse and visual pictures of the Lego parts to construct their 3D visual model. This program also has the capability to allow users to use a mouse to construct a simplified space ship with 3-4 simple components, and then simulate the lift-off. Users select a type of component, then drag and drop these optional components in specific “guided” places within the spaceship structure.

Lego has another program that allows users to select from a very large catalogue of Lego parts and then build on the display screen specific Lego assemblies. Once a new assembly has been constructed, the program has the capability to print out a detailed bill of materials (BOM) of all the pieces used to make this assembly. This BOM can become an Order to buy these parts. The resulting picture of the model is not connected to a simulator. Thus, this modelling system is not “a simulation enabled model”.

### SUMMARY OF THE INVENTION

According to a first aspect of the invention, there is provided a system for modelling a robot design comprising:
a library of active robotic components comprising common and special use robotic components and embedded components;
a 3D graphical workspace comprising a menu for accessing the library of active robotic components and means for positioning selected components onto said workspace for 3D visual modelling of the robot;
a 3D environment creator for adding environmental elements and conditions to the environment;
a simulation-enabled 3D robot model data file (SERM) comprising data pertaining to: the 3D graphic visualizations of the robotic components and the environmental elements; object physics data pertaining to the physical properties for the robotic components and the environmental elements; and active component modules comprising instructions for each robotic component and environmental element;
a 3D simulation engine for simulating functioning of the modeled robot within the simulated environment using information within the SERM; and output means for displaying design specifications for the modelled robot.

According to a second aspect of the invention, there is provided a method for modelling a robot design comprising:
a) providing a system comprising
   a library of active robotic components comprising common and special use robotic components and embedded components;
   a 3D graphical workspace comprising a menu for accessing the library of active robotic components and means for positioning selected components onto said workspace for 3D visual modelling of the robot;
   a 3D environment creator for adding environmental elements and conditions to the environment;
   a simulation-enabled 3D robot model data file (SERM) comprising data pertaining to: the 3D graphic visualizations of the robotic components and the environmental elements; object physics data pertaining to the physical properties for the robotic components and the environmental elements; and active component modules comprising instructions for each robotic component and environmental element;
   a 3D simulation engine for simulating functioning of the modeled robot within the simulated environment using information within the SERM; and
   output means for displaying design specifications for the modelled robot;
b) designing a robot by accessing the library of active robotic components and selecting a robotic component;
c) using the 3D graphical workspace to position the selected robotic component onto the desired location on the 3D graphical workspace for 3D visual modelling of the robot, the selected component being added to the SERM;
d) repeating step (c) until all components of the robot have been selected;
(e) adding environmental objects and environmental conditions using the 3D environment creator;
(f) testing the functionality of the modeled robot in the simulated environment using the 3D simulation engine;
(g) if necessary, repeating step (c) to make modifications to the modeled robot until functionality is satisfactory; and
(h) outputting design specifications for the modeled robot.

### BRIEF DESCRIPTION OF THE DRAWINGS

FIG. 1 is a schematic diagram showing the components of the SERM.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

This invention describes a system and a method to design virtual 3D model of the working robot so it can be tested in a virtual world to test, refine, redesign and improve multiple virtual prototypes of a robot. Once virtually tested, the optimized design specifications are printed out and used to build the optimized robot design.

Our work with companies and researchers who use robotic simulation has identified the following requirements for robotic simulation:
1) A 3D physics based, 3D rendered simulation engine that can execute robot control behaviours developed in one of more programming languages. This is the core of a robot simulator;
2) The 3D robot model must be embedded in a program that provides the instructions for operation of each active component of the robot. Such active components are servo motors, actuators, sensors, cameras, arms, grippers, and any other special device that has been designed to perform tasks or respond to the environment. We will define such a robotic model with its active components programmed to be a “simulation enabled 3D robot model” (SERM). Such a model is a program segment which awaits instructions from the control behaviour program and provides sensor data to the Control program for its determination of what to do next;
3) A 3D environment or world creation and editing capability to import, create or edit the environment in which the robot(s) operate. This allows robots to be tested in the targeted environment(s), and their construction and programming varied accordingly, as discussed herein.
4) A 3D robot model editor that can accept imported 3D robot models, and allow editing of the robot for structure and design, as well as component changes and additions. This allows a robot designer to test the effect of minor and major design changes. Each design change iteration requires a corresponding change to be made to the SERM program to accurately reflect the new capability of the robot. As will become apparent to one of skill in the art, this invention is focused on the processes of creating and maintaining an accurate SERM within the process of creating and operating a robotic simulation.

Other robotic simulation requirements include logging of specific indicators within the simulation. A video logger is such an example, to provide a video of the simulation execution.

The traditional, prior art approach to create a simulation enabled 3D robot model model is:
1) Obtain an existing 3D visual model of the robot or create one using a 3D drawing system such as SolidWorks, Inventor, SolidEdge, 3D StudioMax, Blender or the like;
2) Import this model into the simulation engine and write the program that provides the instructions for operation of each active component of the robot. Examples of such active components include but are by no means limited to servo motors, actuators, sensors, cameras, arms, grippers, and any other special device that has been designed to perform tasks or respond to the environment. As defined such a robotic model with its active components programmed we call a “simulation enabled 3D robot model” (SERM);
3) Import or write the robot behaviour control program to simulate the desired behaviour;
4) Test and refine all programs until all work correctly;
5) Run the simulation tests; and
6) Revise and refine as required to analyze the virtual experiment or system.

If such experiments indicate changes to the robot model design, then such component program segments and other linkages must be re-programmed or modified.

Steps 1 and 2 result in the “simulation enabled 3D robot model” (SERM). The traditional process requires a highly skilled 3D graphical programmer with robotic experience and the process is very time consuming. The new method reduces the time by 50-90% and de-skills the process.

In our first robot simulation products, we developed robot simulators using the traditional method of combining the 3D robot model and all the related component programming inside the simulator program. After developing several simulators for different robots, we realized that too much duplicate, redundant effort was necessary. What we really wanted was a new method so we would not have to repeat the detailed programming for every 3D model and their components.

Accordingly, we began designing a new architecture that would eliminate all the parts of the programming effort so we could create a new robot simulator without any programming. After several design iterations and prototype testing, we determined that the key was to separate the parts of a robot simulator into smaller independent segments that could be combined into a “simulation ready model” with all the required program components in place, ready for the redesigned simulator to execute the simulation.

As we began to evolve working parts of this new architecture, we began to see many advantages of not having to reprogram parts of the 3D model. Then we evolved the simulator design so it would also not require re-programming for every new 3D model. Although there were many design incompatibilities identified, successive iterations resulted in closer customer ready versions. We have used these successive versions in our lab to develop new simulators in a fraction of the time of the traditional method.

Specifically, with this invention, we can redesign a robot and change its components and then repeat the simulation with the new components fully operational. This new method will have a dramatic impact on how novice and experienced roboticists design and test robots, components and then simulate these.

Accordingly, in one embodiment of the invention, there is provided a simulator system for modelling or testing a robot design and a method for using this system.

In some embodiments, the system comprises a simulation-enabled 3D robot model data file (SERM), a library of active robotic components, a 3D graphical workspace for 3D visual modelling of the robot, a 3D environment creator, a 3D simulation engine and an output device.

In some embodiments, the system includes additional libraries for user selection, for example, an environmental conditions library, an environmental object library, a robot model library and the like.

As discussed below, in use, the user accesses the system and begins the process of designing a robot for modelling and/or simulation testing. In some embodiments, the user may upload a partially completed robot design, a robot design from the robot model library for further modification or the SERM of a previously designed (and tested) robot.

As discussed below, the user then accesses the graphic user interface of the library of active components and selects a component which is the dragged and dropped onto the desired location on the 3D graphical workspace for 3D visual modelling of the robot. The selected component is added to the SERM which is discussed in greater detail below. Once all of the desired components have been added, the SERM can be saved and/or the 3D environment creator is used to create the environment in which the SERM will be tested. As will be appreciated by one of skill in the art, the environment may be generated prior to building the robot or a suitable environment may be uploaded to the system from the environment library, as discussed above.

The SERM comprises the following data types: 3D graphic visualizations, which is the data for the 3D visual models of the robot(s) and other objects in the environment; object physics data, which define the physical properties for these visual objects and the active component program modules which are specific to each active component and become a part of the SERM when the user drags and drops a robotic component onto the 3D graphical workspace. These program modules provide the 3D simulation engine or 3D simulator with the functional instructions for each robotic or environmental active component.

The user then runs the 3D simulator image and optionally can record how the robot functions within the environment, as discussed herein.

If the robot's performance is unacceptable or improvements are indicated, the SERM may be accessed to make changes to the robot's control behaviour program and/or components before running the simulation again. The process is repeated until the user is satisfied with the functionality of the robot design, at which point the design specifications are outputted. As will be appreciated by one of skill in the art, the design specifications may be printed out or they may appear on an output screen or may be outputted to a file.

As discussed herein, the system comprises an active robotic component program library.

The library of active robotic component program segments comprises a plurality of common and special use robotic and embedded components. This library includes sensors such as sonar, infrared, light sensitive, laser scanners, cameras (still, video, infrared), motion detective sensors, motors, actuators, microphones, speakers, sniffers, sound analyzers, wheels, track-drives, legs, arms, grippers, hands, joints, conveyors, and the like. These program segments are designed to link and compile into executable code in the simulator, as discussed below. It is of note that this library is arranged to be amended or enhanced independently from this method. This means that new components can be added to the library.

As discussed below, the system is arranged such that the library is accessed by a menu drop-down list comprising the names and/or picture icons of each component.

Each component can be selected by the user and dragged onto a 3D graphical workspace, which displays a 3D visual model of the robot onto which the user drags and drops the corresponding active components onto the targeted 3D visual model. When such a component is added onto the 3D model, the program segment is added into the pending SERM data file for each robot. In this manner, the components are interconnected for eventual use in the virtual environment.

In a preferred embodiment, the system includes a library of one or more 3D visual models of common robots, components and environmental objects.

The user begins the process by selecting a menu command to “import” a pre-existing 3D visual model of a robot or robot component. The 3D model file is selected from a drop-down list or the name of the file containing the 3D visual model is specified and the 3D model is displayed in the visual 3D graphical “workspace”.

As discussed above, the user drags and drops each desired component onto the 3D visual model displayed in the workspace. This process creates a working model of the SERM for subsequent final processing and saving as a SERM data file, when all desired components have been added.

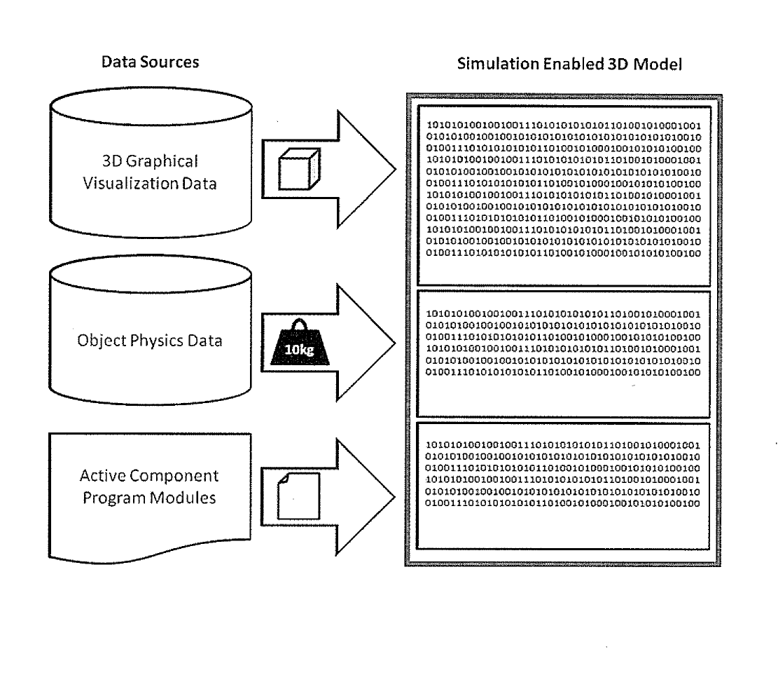

The completed SERM data file contains three types of data as illustrated in FIG. 1.

In some embodiments, the SERM data file is added into a SERM library and can be accessed by menu command and added into the workspace. In these embodiments, the SERM data file(s) can be imported from the SERM library into the simulator for simulation of the robot(s) or component(s).

As a result of this arrangement, if changes are desired as a result of the simulation/modelling process, the saved SERM can be reloaded from the SERM library into the workspace and amended by removing, changing or adding any component or embedded active component, as discussed herein.

A subset of the active components library is a set consisting of physical construction components which are not active but exist for construction of robots, components or environmental objects. These objects include buildings, industrial yards, railroad tracks, office buildings, office spaces, apartment spaces, residential areas, streets, sidewalks, trees, houses, furniture, machine forms, packaging materials, sports devices and objects, vehicles of all types, etc.

In a robotic prototyping situation where a designer wishes to use this method to test and refine a robotic design, the resulting SERM data provides the necessary and sufficient data for building a robot according to the specifications developed during the modeling process. This data includes; list of all parts and components with 3D geometric definitions of each part. For active components the data includes physical dimensions, mass, materials, performance and operating data. For example for a scanner the data includes physical size, weight, scan rate, scan distance, scan angle, frequency, power usage, connector details, operational limits. This data can be electronically assembled and displayed (or printed) as design, construction or manufacturing specifications suitable for a variety of uses such as novice training, to serious manufacturing.

Each SERM contains the following data types (shown schematically in FIG. 1):
1) 3D Graphical Visualizations:

3D visual models of robots and various other objects in the environment to be simulated in the accompanying simulator. The format is similar to standard 3D data except for additional structures and constraints that are required to link to physical and behavioural processes defined in this method.
2) Object Physics Data:

Data structures that define physical properties for corresponding graphical visual objects. The structures define mass, dimensions, friction, surface materials, colliders and other properties that robots and other objects in the system may interact with.
3) Active Component Program Modules:

These are program modules that are specific to each active component. These become part of a saved SERM when the user drags and drops a robotic component onto the 3D visual model. It is these program modules which provide the simulator with the functional instructions for each robotic or environmental active component. All sensors, actuators and other devices use active component program modules to define the function, internal processes, inputs and outputs specific to its function. The communication between modules may be also partially defined in these program modules, with the simulator controlling and executing the specific communication.
This method utilizes a common computer such as a laptop, desktop or business/industrial computer with a pointing device (such as a mouse) or touch screen, file storage, processor(s) and memory and common operating software and appropriate programming languages.

This method has a graphical user interface (GUI) that gives the user the ability to use a mouse pointing device or a touch sensitive display screen so menus can be expanded and selections can be made by pointing and selecting menu options.

The pointing and selecting process can also allow a user to move graphical objects in a drag and drop sequence, thus adding or moving an existing graphical object on the display screen.

One such menu option allows an existing 3D robot model to be imported from an externally created 3D creation system.

The imported 3D model can be a new robot model, a 3D model of a new component or a 3D model that has previously been created from this process. Thus once a specific robot or component has been enabled by this process, it is immediately available and reusable.

Another menu item allows the user to select a specific component from a drop down list and drag that component onto the corresponding part of the imported 3D model. The act of dropping this component onto the 3D picture of the component accomplishes the step of writing the program segments that provide the instructions for operation of each active component of the robot.

The selection of components is repeated until all active components are “simulation enabled”.

Once all of the components have been enabled, the resulting SERM is ended and the SERM is saved for subsequent import into the simulator or for further use as another active component within this “simulation enabling” process.

The immediate benefit of this process is that it changes the enabling of a 3D robot model from a programming task to a non-programmer task that can be performed with minimal training by designers and novice robotic enthusiasts. The benefit is also applicable to experienced roboticists, since they no longer need to write the programs to enable their 3D robot model to be simulation ready.

Once a specific robot has been simulation-enabled, it can be made available to an unlimited number of other users thus providing them with access to the SERM without programming, and without the programming time delay.

Since the process can also be applied to basic robot components, new more powerful or complex components can be created from the basic start up components.

The result will be that many who cannot program will now have access to robotic simulation and be able to create new robotic models for research, education, entertainment, industrial and medical usage. This access will dramatically increase the growth of robotics, and the importance of virtual robotics design and simulation.

There are many applications of 3D simulation related to robotics and many that are independent of robotics. Many do involve the creation of “simulation-enabled 3D model(s)” (SEM). A few such examples are: manufacturing processes; mobile machines in construction sites; vehicles/automobiles in a race; human beings or animals in a virtual game or endeavour; the flow of patients in a medical setting; and the like. Thus the more general application of this SERM to a SEM is an extension into other non-robot applications.

The adaptation of the SERM method to non-robots requires only that the initial starting components be defined as those components that pertain to the specific domain. For example, for a manufacturing simulation the models are various operators and machines, each having a set of capabilities and components for moving, processing, welding, joining, checking, painting, etc. The models can also be various materials that are processed. To be simulated each such object (operator, machine, material, etc) requires a set of capability based program instructions to allow the model to “act out” their capabilities as per the behaviour control program instructions.

The analogy holds for vehicles, humans, animals, any object whether real or fictitious, animate or inanimate. Simple stable objects which do not move, only require that they exist and correctly obey the laws of physics for a realistic simulation.

If the simulation is not physics based, but the simulation does require simulation enabled 3D models, then the SERM method is still applicable for the easy creation of such SEMs.

Therefore the SERM method can be applied to any 3D object model that is to become part of a 3D simulation.

As discussed herein, there is provided a method for the enabling of a 3D graphical model of a robot or component into a simulation-ready 3D or simulation-enabled model with the corresponding program segments and linkages in place, so that the resulting simulation enabled 3D model is immediately ready to be simulated.

As discussed above, the invention also provides for the creation of new components for usage in robots and complex processes. As discussed above, these new components can be stored in a library for subsequent access in other processes. In some embodiments, the libraries of SERMs and/or components may be specific for specific industries, fields of endeavours and applications which will provide access for such individual to new tools for considering robotics in such industries, endeavours and applications.

As discussed above, a key benefit of the invention is that it provides an individual who is not a robotic programmer with easy access to simulation enabled 3D robotic models and components for exploring and building virtual 3D robots for simulation experiments and entertainment.

In some embodiments, the system can be arranged to have Internet access, thereby allowing users to share data.

In some embodiments, the SERM component may be part of a larger system, such system being in the form of a purposeful endeavour such as a game, a learning exercise or system, or other purpose.

While the preferred embodiments of the invention have been described above, it will be recognized and understood that various modifications may be made therein, and the appended claims are intended to cover all such modifications which may fall within the spirit and scope of the invention.

1. A system for modelling a robot design comprising:
a library of active robotic components comprising common and special use robotic components and embedded components;
a 3D graphical workspace comprising a menu for accessing the library of active robotic components and means for positioning selected components onto said workspace for 3D visual modelling of the robot;
a 3D environment creator for adding environmental elements and conditions to the environment;
a simulation-enabled 3D robot model data file (SERM) comprising data pertaining to: the 3D graphic visualizations of the robotic components and the environmental elements; object physics data pertaining to the physical properties for the robotic components and the environmental elements; and active component modules comprising instructions for each robotic component and environmental element;
a 3D simulation engine for simulating functioning of the modeled robot within the simulated environment using information within the SERM; and
output means for displaying design specifications for the modelled robot.

2. The system according to claim 1 including an environmental conditions library.

3. The system according to claim 1 including an environmental object library.

4. The system according to claim 1 including a robot model library.

5. The system according to claim 1 wherein the library of active robotic components are selected from the group consisting of sonar sensors, infrared sensors, light sensitive sensors, laser scanners, cameras, motion detective sensors, motors, actuators, microphones, speakers, sniffers, sound analyzers, wheels, track-drives, legs, arms, grippers, hands, joints, conveyors and combinations thereof.

6. A method for modelling a robot design comprising:
a) providing a system comprising
a library of active robotic components comprising common and special use robotic components and embedded components;
a 3D graphical workspace comprising a menu for accessing the library of active robotic components and means for positioning selected components onto said workspace for 3D visual modelling of the robot;
a 3D environment creator for adding environmental elements and conditions to the environment;
a simulation-enabled 3D robot model data file (SERM) comprising data pertaining to: the 3D graphic visualizations of the robotic components and the environmental elements; object physics data pertaining to the physical properties for the robotic components and the environmental elements; and active component modules comprising instructions for each robotic component and environmental element;
a 3D simulation engine for simulating functioning of the modeled robot within the simulated environment using information within the SERM; and
output means for displaying design specifications for the modelled robot;
b) designing a robot by accessing the library of active robotic components and selecting a robotic component;
c) using the 3D graphical workspace to position the selected robotic component onto the desired location on the 3D graphical workspace for 3D visual modelling of the robot, the selected component being added to the SERM;
d) repeating step (c) until all components of the robot have been selected;
(e) adding environmental objects and environmental conditions using the 3D environment creator;
(f) testing the functionality of the modeled robot in the simulated environment using the 3D simulation engine;
(g) if necessary, repeating step (c) to make modifications to the modeled robot until functionality is satisfactory; and
(h) outputting design specifications for the modeled robot.

7. The method according to claim 6 wherein the output means is a printer.

8. The method according to claim 6 wherein the output means is a visual display.

9. The method according to claim 6 including step (i) building a robot according to the outputted design specifications.

10. The method according to claim 6 wherein the system includes an environmental conditions library.

11. The method according to claim 6 wherein the system includes an environmental object library.

12. The method according to claim 6 wherein the system includes a robot model library.

13. The method according to claim 6 wherein the library of active robotic components are selected from the group consisting of sonar sensors, infrared sensors, light sensitive sensors, laser scanners, cameras, motion detective sensors, motors, actuators, microphones, speakers, sniffers, sound analyzers, wheels, track-drives, legs, arms, grippers, hands, joints, conveyors and combinations thereof.
